(19) United States
(12) Patent Application Publication
(10) Pub. No.: US 2017/0044995 A1
(43) Pub. Date: Feb. 16, 2017

(54) METHOD FOR SELECTING OPERATING POINTS OF A GAS TURBINE

(71) Applicant: Siemens Aktiengesellschaft, Munich (DE)

(72) Inventors: Christian Amann, Bottrop (DE); Björn Beckmann, Duisburg (DE); Eberhard Deuker, Mülheim an der Ruhr (DE); Kai Kadau, Lake Wylie, SC (US); Boris Ferdinand Kock, Ratingen (DE); Georg Rollmann, Mülheim Ruhr (DE); Sebastian Schmitz, Berlin (DE); Marcel Zwingenberg, Xanten (DE)

(73) Assignee: Siemens Aktiengesellschaft, Munich (DE)

(21) Appl. No.: 15/306,567

(22) PCT Filed: Apr. 22, 2015
(86) PCT No.: PCT/EP2015/058637

§ 371 Date: Oct. 25, 2016

(30) Foreign Application Priority Data
May 5, 2014 (EP) 14166968.9

(51) Int. Cl. F02C 9/28

(52) U.S. Cl. CPC F02C 9/28; F05D 2260/821; F05D 2270/08; F05D 2270/301; F05D 2270/303

(57) ABSTRACT

A method for selecting operating points of a gas turbine while taking into consideration at least one controlled variable, the operating points being defined at least by parameter combinations of manipulated variables, wherein the operating points are automatically selected on the basis of already known parameter combinations by using an interpolation method, the Kriging interpolation method being used as the interpolation method.

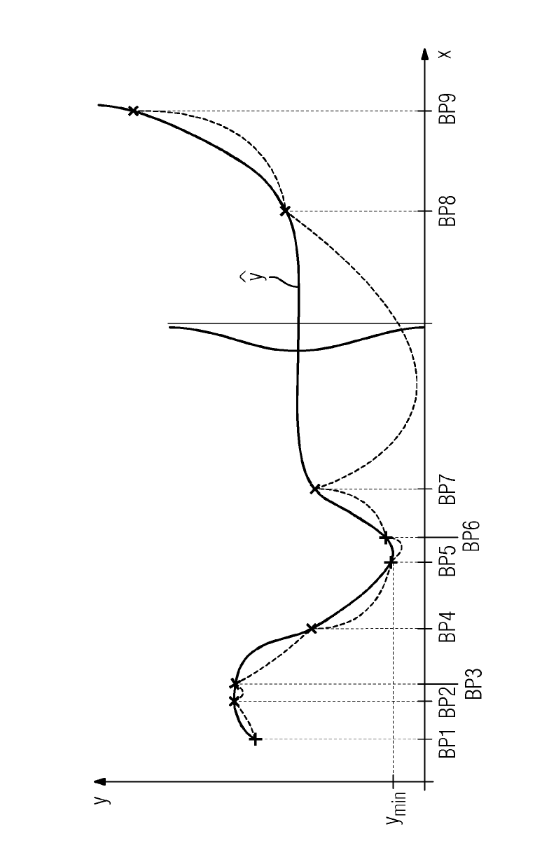

### CROSS REFERENCE TO RELATED APPLICATIONS

This application is the US National Stage of International Application No. PCT/EP2015/058637 filed Apr. 22, 2015, and claims the benefit thereof. The International Application claims the benefit of European Application No. EP14166968 filed May 5, 2014. All of the applications are incorporated by reference herein in their entirety.

### FIELD OF INVENTION

The present invention relates to a method for selecting operating points of a gas turbine while taking into consideration at least one controlled variable, the operating points being defined at least by parameter combinations of manipulated variables.

### BACKGROUND OF INVENTION

Gas turbines are continuous-flow machines, usually having a compressor, a turbine and a burner arrangement which comprises a plurality of burners and at least one combustion chamber, wherein the burners form different burner stages, such as for example a pilot burner stage and a plurality of main burner stages. During the operation of a gas turbine the compressor draws in ambient air and compresses it. The compressed air is then directed to the individual burners in which it is mixed with fuel. The fuel-air mixtures that are generated are then burned in the combustion chamber. The hot combustion exhaust gases produced as a result of the combustion are then fed into the turbine, where they drive the guide vanes. In this way, thermal energy from the combustion exhaust gases is converted into mechanical work, which is used both to drive the compressor and to drive a consumer, such as for example a generator for generating electrical power.

During the operation of a gas turbine, it is important to ensure that values of predefined controlled variables lie within permitted target ranges. One example of an important controlled variable is the combustion stability of the gas turbine, which is also known as the “hum behavior”. Instabilities in the combustion are induced in particular as a result of resonant fluctuations in the release of heat, and can cause oscillations and vibrations of the combustion chamber, which reduce the service life of the combustion chamber and shorten maintenance intervals.

Accordingly, it is important to ensure that the permissible limit values are not exceeded. A further important controlled variable is the emission behavior of the gas turbine, which is also affected by the combustion stability. In many countries, stipulated emission limit values must not be exceeded. Here also, compliance with the permissible values must be guaranteed.

A correct setting of one or more controlled variables can be achieved by the selection of suitable operating points of the gas turbine, which are defined at least by parameter combinations of manipulated variables. Examples of manipulated variables are, in particular, a total fuel volume flow supplied to the gas turbine and a distribution of the total fuel volume flow over the individual burner stages of the gas turbine. Both manipulated variables have a critical effect on both the emission behavior and the combustion stability of the gas turbine. One problem, however, is that the suitable operating points vary from gas turbine to gas turbine, even when the gas turbines are identical in design. The reasons for this variation are in particular different environmental conditions, fluctuating gas quality and specific customer requirements. The operating points of a gas turbine plant can also be subject to changes over time. The result of this is that the selection of suitable operating points for each gas turbine has to be made separately, as is also the case for readjustment of operating points.

The selection of suitable operating points of a gas turbine has up to now been performed manually. The procedure is primarily based on trajectories and characteristic diagrams for already existing gas turbines, which are then modified. Due to the large parameter space and the multiplicity of influencing factors, however, a manual selection of operating points requires a great deal of experience and, moreover, is also extremely time-consuming. It is also difficult to respond to unforeseen deviations in the controlled variables.

### SUMMARY OF INVENTION

On the basis of this prior art, it is an object of the present invention to create an alternative method of the above-mentioned type, which is simple, fast and cost-effective to implement.

To achieve this object, the present invention creates a method of the above-mentioned type, which is characterized in that the operating points are selected automatically using an interpolation method based on already known parameter combinations, the Kriging interpolation method being used as the interpolation method. Very good results have been obtained using this interpolation method. For the known parameter combinations, according to the invention the parameter combinations considered are those for which the corresponding values of the controlled variables are known. The reason why the use of an interpolation method is advantageous in the selection of operating points is that a very good balance between the exploration of the parameter space and the exploitation of information already obtained is made possible, leading to a very efficient scanning of the parameter space. On the basis of the parameter combinations of the manipulated variables which already exist or have already been encountered, the next operating point in question can be calculated under the constraint that the expected improvement assumes a maximum value. In this way, optimized operating points can be automatically identified and selected within a short period of time.

The manipulated variables preferably comprise a total fuel volume flow supplied to the gas turbine, and/or a distribution of the total fuel volume flow supplied to the gas turbine over individual burner stages of the gas turbine, and/or a gas turbine outlet temperature and/or a position of guide vanes of the gas turbine.

The controlled variables preferably describe the emission behavior of the gas turbine and/or the combustion stability of the gas turbine, as these controlled variables influence the operating behavior of the gas turbine particularly strongly.

In the selection of operating points the influence of interfering variables is advantageously taken into consideration, such as for example the ambient temperature and/or the air humidity of the environment and/or the ambient pressure and/or the density and calorific value of the fuel, to name just a few examples.

In accordance with one variant of the present invention, the already known parameter combinations are such as have been determined by manual variation of the parameters, wherein in the manual variation of the parameters, known parameter combinations of an already existing gas turbine are presupposed.

Further features and advantages of the present invention shall become clear on the basis of the following description of a method in accordance with an embodiment of the present invention, by reference to the attached drawing.

### BRIEF DESCRIPTION OF THE DRAWINGS

The sole FIGURE is a schematic diagram illustrating a Kriging interpolation for the one-dimensional case.

### DETAILED DESCRIPTION OF INVENTION

According to Kriging an expected improvement is given by

$$EI ( x ) = ( y min - \hat{y} ( x ) ) * Φ ( \frac{y min - \hat{y} ( x )}{\hat{s} ( x )} ) + \hat{s} * φ ( \frac{y min - \hat{y} ( x )}{\hat{s} ( x )} )$$

In this equation x indicates the parameter setting, ymin the previously found minimum of the controlled variable, ŷ the value of the controlled variable for x predicted by the Kriging interpolator, and ŝ the estimated standard deviation of the controlled variable, wherein Φ and φ are the distribution function and density function of the standard normal distribution respectively.

The diagram shows an example of how the Kriging interpolation works for the one-dimensional case. The operating points BP1 to BP9 are already known. This means that, for the operating points BP1 to BP9, the values which the controlled variable assumes at these operating points are known. Each of these pairs are represented by corresponding crosses. The values of the controlled variables for the operating points BP1 to BP9 might have been determined, for example, by manual variation of the x values. The solid line which connects the crosses together represents the function of the values of the controlled variable predicted by the Kriging interpolator for different values of x. The dashed line represents a lower confidence band. The uncertainty is by definition greatest at the points where only a small amount of information is available, in this case between the operating points BP7 and BP8, which are furthest away from each other along the x axis. Also shown is a lower limit, which defines the expected improvement. Accordingly, it is entirely possible for a further operating point BP10 to be located in an area where although no particularly low values for y were found, the information content is still low.

In the method according to the invention the Kriging method shown by way of example in the drawing is applied in the multi-dimensional parameter space, in order to systematically search for promising new operating points based on already known operating points and, should these prove to be appropriate, to automatically select them. This procedure allows in principle any number of manipulated variables and controlled variables to be taken into consideration. The operating points here are defined by parameter combinations of the manipulated variables. Alternatively, operating points can be defined by parameter combinations consisting of manipulated variables and interfering variables.

The manipulated variables can comprise a total fuel volume flow supplied to the gas turbine, and/or a distribution of the total fuel volume flow supplied to the gas turbine over individual burner stages of the gas turbine, and/or a gas turbine outlet temperature and/or a position of guide vanes of the gas turbine, to name just a few examples.

The controlled variables can describe, for example, the emission behavior of the gas turbine and/or the combustion stability of the gas turbine.

Examples of interfering variables are the ambient temperature and/or the air humidity of the environment and/or the ambient pressure.

Although the invention has been illustrated and described in greater detail by means of the preferred exemplary embodiment, the invention is not restricted by the examples disclosed, and other variations can be derived therefrom by the person skilled in the art without departing from the scope of protection of the invention.

What is claimed is:

1. A method for selecting operating points of a gas turbine while taking into consideration at least one controlled variable, the operating points being defined at least by parameter combinations of manipulated variables, the method comprising:
selecting the operating points automatically using an interpolation method based on already known parameter combinations,
wherein the Kriging interpolation method is used as the interpolation method.

2. The method as claimed in claim 1,
wherein the manipulated variables comprise a total fuel volume flow supplied to the gas turbine, and/or a distribution of the total fuel volume flow supplied to the gas turbine over individual burner stages of the gas turbine, and/or a gas turbine outlet temperature and/or a position of guide vanes of the gas turbine.

3. The method as claimed in claim 1,
wherein the controlled variables describe the emission behavior of the gas turbine and/or the combustion stability of the gas turbine.

4. The method as claimed in claim 1,
wherein in the selection of operating points the influence of interfering variables is taken into consideration.

5. The method as claimed in claim 4,
wherein the interfering variables comprise the ambient temperature and/or the air humidity of the environment and/or the ambient pressure.

6. The method as claimed in claim 1,
wherein the already known parameter combinations are such as have been determined by manual variation of the parameters.

7. The method as claimed in claim 6,
wherein in the manual variation of the parameters, known parameter combinations of an already existing gas turbine are presupposed.
